(19) United States
(12) Patent Application Publication
(10) Pub. No.: US 2024/0095656 A1
(43) Pub. Date: Mar. 21, 2024

(54) Systems and Methods for Generating and Utilizing Dynamic Isochrones for Delivery

(71) Applicant: Uber Technologies, Inc., San Francisco, CA (US)

(72) Inventors: Philip Allen Brown, San Francisco, CA (US); Vidyut Vishnu Jadhav, Berkeley, CA (US); Yingchao Liu, San Mateo, CA (US)

(21) Appl. No.: 17/945,755

(22) Filed: Sep. 15, 2022

(51) Int. Cl. G06Q 10/0835

(52) U.S. Cl. CPC G06Q 10/08355

(57) ABSTRACT

Systems and methods for generating and using geozones (e.g., merchant-specific isochrones) to rank merchants within a delivery service application. The system can obtain data including a merchant location. The method includes generating a geozone for the respective merchant based on the merchant location and an estimated travel time to various subzones. The method includes storing the geozone for the merchant. The method includes ranking one or more merchants based on their respective geozones and a drop-off location associated with a delivery service request. The method includes facilitating the delivery service. The method includes providing progress updates to a user associated with various progress points of the delivery service.

### FIELD

The present disclosure generally relates to dynamically generating isochrone based geozones to use for ranking and displaying candidate merchants for orders within a delivery service application. More particularly, the present disclosure is directed to generating geozones to be used for selecting, ranking, and displaying candidate merchant orders associated with a proximity to a drop-off location.

### BACKGROUND

Food delivery services allow a user to request a service that may be performed by a vehicle and/or courier. For instance, a user may request, through a food delivery service application, a food delivery service having a pick-up location, a drop-off location, and an item for delivery. Candidate merchants can be selected and ranked for display based on various criteria. A courier can be assigned to perform the food delivery service for the user. This can include transporting the delivery of the item to the drop-off location.

### SUMMARY

Aspects and advantages of embodiments of the present disclosure will be set forth in part in the following description, or may be learned from the description, or may be learned through practice of the embodiments.

One aspect of the present disclosure is directed to a computing system. The computing system includes one or more processors and one or more tangible, non-transitory, computer readable media that store instructions that are executable by the one or more processors to cause the computing system to perform operations. The operations include obtaining data indicative of a merchant location. The operations include generating an initial delivery zone around the merchant location. The operations include populating the initial delivery zone with a plurality of sub-zones. The operations include determining an estimated travel time from the merchant location to each respective sub-zone of the plurality of sub-zones. The operations include comparing the estimated travel time for each respective sub-zone to a threshold travel time. The operations include filtering the sub-zones based at least in part on: (i) the comparing of the estimated travel time for each respective sub-zone to the threshold travel time; or (ii) one or more geographic boundaries. The operations include storing data indicative of the filtered sub-zones as a first geozone associated with a first merchant associated with the merchant location. The operations include obtaining data indicative of initiation of a delivery service application launch, wherein the data comprises at least a drop-off location. The operations include determining the first merchant is an available merchant based at least in part on the first geozone and the drop-off location. The operations include ranking the first merchant and one or more additional merchants from a group of merchants based at least in part on the first geozone associated with the first merchant. The operations include transmitting, to a user device, instructions to cause a user interface to present the ranked merchants in a selectable format. The operations include obtaining user input data indicative of user selection of one or more items associated with at least one merchant of the ranked merchants. The operations include transmitting, to a courier device, data indicative of a request to complete a delivery service associated with the user input data. The operations include obtaining data indicative of acceptance of the request. The operations include obtaining data indicative of one or more progress points associated with the delivery service. The operations include transmitting, to the user device, instructions to cause the user interface to present updates associated with the one or more progress points associated with the delivery service.

Another Example aspect of the present disclosure is directed to a computer-implemented method. The method includes obtaining data indicative of a merchant location. The method includes generating an initial delivery zone around the merchant location. The method includes populating the initial delivery zone with a plurality of sub-zones. The method includes determining an estimated travel time from the merchant location to each respective sub-zone of the plurality of sub-zones. The method includes comparing the estimated travel time for each respective sub-zone to a threshold travel time. The method includes filtering the sub-zones based at least in part on: (i) the comparing of the estimated travel time for each respective sub-zone to the threshold travel time, or (ii) one or more geographic boundaries. The method includes determining a first geozone for a first merchant. The method includes storing data indicative of the first geozone. The method includes obtaining data indicative of initiation of a delivery service application launch, wherein the data comprises at least a drop-off location. The method includes determining the first merchant is an available merchant based at least in part on the first geozone and the drop-off location. The method includes ranking the first merchant and one or more additional merchants from a group of merchants based at least in part on the first geozone associated with the first merchant. The method includes transmitting, to a user device, instructions to cause a user interface to present the ranked merchants in a selectable format. The method includes obtaining user input data indicative of user selection of one or more items associated with at least one merchant of the ranked merchants. The method includes transmitting, to a courier device, data indicative of a request to complete a delivery service associated with the user input data. The method includes obtaining data indicative of acceptance of the request. The method includes obtaining data indicative of one or more progress points associated with the delivery service. The method includes transmitting, to the user device, instructions to cause the user interface to present updates associated with the one or more progress points associated with the delivery service.

Yet another example aspect of the present disclosure is directed to one or more non-transitory computer readable media storing instructions that are executable by one or more processors to perform operations. The operations include obtaining data indicative of a merchant location. The operations include generating an initial delivery zone around the merchant location. The operations include populating the initial delivery zone with a plurality of sub-zones. The operations include determining an estimated travel time from the merchant location to each respective sub-zone of the plurality of sub-zones. The operations include comparing the estimated travel time for each respective sub-zone to a threshold travel time. The operations include filtering the sub-zones based at least in part on: (i) the comparing of the estimated travel time for each respective sub-zone to the threshold travel time, or (ii) one or more geographic boundaries. The operations include storing data indicative of the filtered sub-zones as a first geozone associated with a first merchant associated with the merchant location. The operations include obtaining data indicative of initiation of a delivery service application launch, wherein the data comprises at least a drop-off location. The operations include determining the first merchant is an available merchant based at least in part on the first geozone and the drop-off location. The operations include ranking the first merchant and one or more additional merchants from a group of merchants based at least in part on the first geozone associated with the first merchant. The operations include transmitting, to a user device, instructions to cause a user interface to present the ranked merchants in a selectable format. The operations include obtaining user input data indicative of user selection of one or more items associated with at least one merchant of the ranked merchants. The operations include transmitting, to a courier device, data indicative of a request to complete a delivery service associated with the user input data. The operations include obtaining data indicative of acceptance of the request. The operations include obtaining data indicative of one or more progress points associated with the delivery service. The operations include transmitting, to the user device, instructions to cause the user interface to present updates associated with the one or more progress points associated with the delivery service.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example system for generating merchant geozones for ranking merchants to be presented for user selection according to aspects of the present disclosure.

FIG. 2 depicts a block diagram of a process flow associated with fulfilling an order request according to aspects of the present disclosure.

FIG. 3 depicts a block diagram of a process flow associated with generating and validating merchant geozones according to aspects of the present disclosure.

FIGS. 4A-D depict example radial delivery zones and merchant geozones according to aspects of the present disclosure.

FIGS. 4E-4H depict example steps for generating geozones according to aspects of the present disclosure.

FIGS. 5A-5B depict an example method according to example embodiments of the present disclosure.

FIG. 6 depicts a block diagram of example systems according to example embodiments of the present disclosure.

FIG. 7 depicts a block diagram of example systems according to example embodiments of the present disclosure.

### DETAILED DESCRIPTION

Generally, the present disclosure is directed to improved systems and methods for generating and using geozones (e.g., merchant-specific isochrones) to rank merchants within a delivery service application. More particularly, the present disclosure is directed to features for generating geozones for merchants based on travel time between the merchant location and sub-zones. Additionally, or alternatively, the disclosure is related to determining geozones based on generating multiple merchant-sub-zone pairs based on intent signals, ranking the merchants, and displaying merchants with respective menu items for user selection. Aspects of the present disclosure can include filtering sub-zones based on a comparison of the respective merchant-sub-zone travel time to a threshold travel time.

Many delivery services define delivery zones using a set radius. This results in surfacing merchants located within a specific haversine distance. Increasing merchant selection options by increasing delivery zone radius can increase user engagement with a delivery service. However, using haversine distance can cause issues when, for example, an order request drop-off location is one mile away haversine distance, but is located across a body of water. In an instance such as this, although the distance from a bird's eye view is below a set threshold, the distance that a courier must travel to complete the delivery service request can exceed a threshold distance and/or travel time. For example, if a drop-off location is located a mile away across a body of water, a courier may have to travel along the coast and/or use a bridge or tunnel to complete the service request. This can result in inefficient allocation of resources (e.g., couriers). Additionally, this can result in customer dissatisfaction especially if the delivery item is time sensitive (e.g., a frozen item, an item that will become cold). As further explained herein, the technology of the present disclosure helps to limit the potential selection of merchants based on a merchant geozone (e.g., an isochrone). As such, the system can cut down on data transfer associated with a number of merchant options being displayed on a user device (e.g., associated with a consumer) and more efficiently rank merchants for display on a user device based on estimated delivery times as opposed to haversine distances between couriers, merchants, and drop-off locations.

By way of example, the merchant could include a restaurant located in a dense urban area. A standard circle comprising a set radius could be used to define an acceptable delivery zone for the merchant (e.g., radial delivery zone). However, two points located on the edge of the circle may have widely varying travel times. For example, a first point on the northern side of the circle may require 10 to 15 minutes of travel time whereas a point on the southern end of the circle may require 30 or 40 minutes of travel time.

The current disclosure can generate geozones for each respective merchant within a market to define a delivery area (e.g., geozone) based on estimated travel time and other intent signals. For example, intent signals can include supply of couriers, demand of delivery options, supply of cuisine, well roundedness of selection options, etc. Based on intent signals, the geozones can be expanded or contracted to account for varying intent signals. For instance, a delivery service can be associated with merchants (e.g., restaurants, convenience stores, etc.). The delivery service can facilitate the receipt and delivery of a delivery service request via an operations computing system (e.g., a network system/platform).

In accordance with an example implementation, a computing system can obtain intent signal data provided via client computing devices, system computing devices, user input, etc. The intent signal data can be indicative of supply of couriers, demand for particular restaurants, user data associated with user preference on cuisine type, user data associated with recent searches for merchants not currently available due to a smaller geozone, etc. In response to obtaining intent signal data, the system can determine an initial radius. The system can generate an initial delivery zone. For example, the initial delivery zone can be a radial delivery zone. The radial delivery zone can be defined by a circle with a radius equal to the initial radius.

The system can divide the radial delivery zone into sub-zones. The sub-zones can be in any polygon shape. For example, the sub-zones can be in the shape of a hexagon. For each respective sub-zone within the radial delivery zone, the system can determine an expected travel time from the merchant to the respective sub-zone.

The system can filter the sub-zones based on filtering criteria. The filtering criteria can include for example, a threshold time between the respective sub-zone and the merchant, and/or a threshold travel distance between the respective sub-zone and the merchant. By filtering the sub-zones to a narrower subset of sub-zones, the system can process the most relevant data and use less bandwidth and computational resources. In some implementations, the system can filter the sub-zones based at least in part on determining a deliverability status for each respective sub-zone of the plurality of sub-zones. The deliverability status can represent whether an order request can be fulfilled to a drop-off location in a respective sub-zone based on filtering criteria. The system can determine a first sub-zone of the plurality of sub-zones is in a location that cannot be traversed by available transportation means. The system can remove the first sub-zone based on determining the first sub-zone cannot be traversed by available transportations means (e.g., is not accessible by a motorized vehicle, is a location in the middle of a body of water, etc.). The system can determine a first sub-zone of the plurality of sub-zones is in a location that can be traversed by available transportation means. The system can maintain the first sub-zone based on determining the first sub-zone can be traversed by available transportation means.

The technology of the present disclosure can provide a number of technical effects and benefits. The technology of the present disclosure can improve the process of geozone generation as well as merchant selection and ranking based on the generated geozones. For instance, aspects of the described technology can allow for more efficient and intelligent surfacing of merchants within a delivery service application. The system can include a model that can provide a basis by which to evaluate merchant-sub-zone pairs and ultimately merchant recommendations to users. This can help reduce the computational processing and bandwidth usage by decreasing the number of options a user has to choose from thus decreasing the amount of user input which must be processed by the computing system. Moreover, the system can periodically update the merchant geozones (e.g., isochrones).

Aspects of the current disclosure can provide additional benefits including reduced payload and bandwidth usage upon processing an order request. The merchant geozones can be generated in an offline model. The generated merchant isochrones can be stored in a database accessible by the computing system. By generating the isochrones offline and making them accessible, the system can decrease bandwidth usage needed for real-time calculations. By way of example, by offloading this processing and storing the finalized geozones, when merchant information is requested by the system, the geozones can be surfaced from the storage location to a server computing system nearly instantaneously. The system can batch upload the generated geozones for each respective merchant. Moreover, this can result in no further need of caching certain merchant data returned in response to system queries for merchant information. These geozones can be fed to a merchant selection engine and deliverability engine which can use the geozones to determine the deliverability of one or more merchants for a respective user. Further, the storage of the geozones in an offline location allows for data validation of the generated geozones. The data validation can be done by a machine-learned model. For example, the system can generate an updated geozone. The system can check the geozone against a ground truth geozone (e.g., a previously generated geozone, human generated geozone, etc.). The system can correct any deficiencies detected and/or return to a prior state (e.g., historical geozone) upon detection of a discrepancy.

The technology described herein includes the collection of data and provision of certain content to users associated with a vehicle service. Users can be given the opportunity to customize data collection and provision features. Data collection and provision can be configured with options for permissions to be obtained from users such that data is collected or provided for authorized use in accordance with the disclosed techniques. For example, a user can control whether certain usage data is collected and/or whether certain content is provided to the user (e.g., through opt-out features, settings). Any personal data can be removed, and data can be stored in a secured, anonymized manner. In this manner, the users can be provided control over what data is collected, used, and provided to a user for the implementations described herein.

While the present subject matter has been described in detail with respect to specific example embodiments and methods thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. With reference to the figures, example embodiments of the present disclosure will be discussed in further detail.

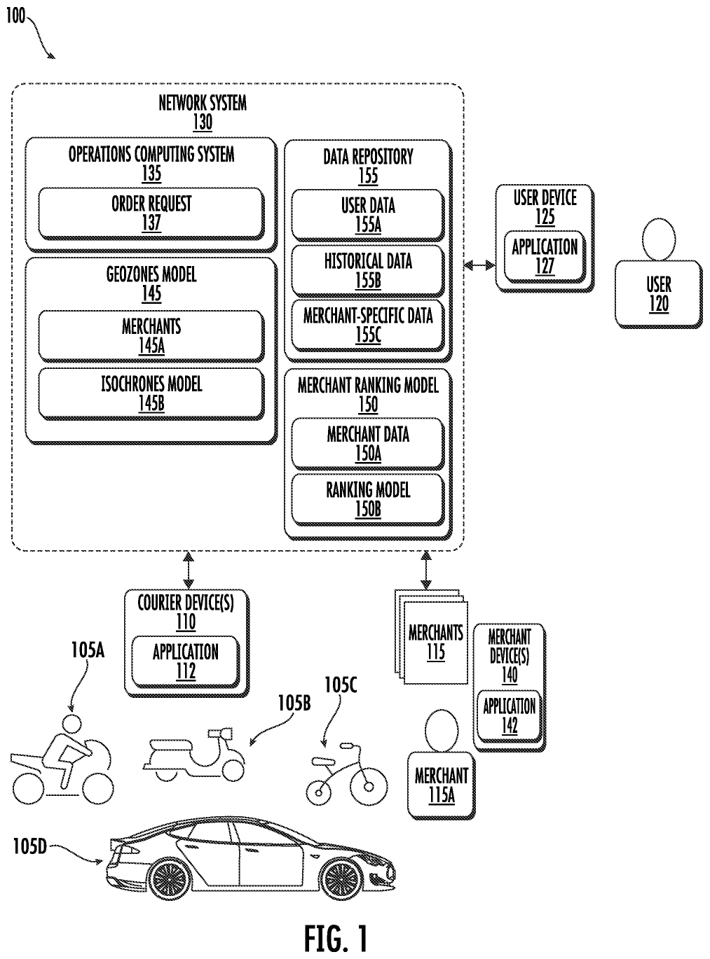

FIG. 1 depicts a block diagram of an example system 100 for dynamic isochrone generation for delivery service geozones. As illustrated, FIG. 1 shows a system 100 that can include one or more vehicles 105A-D (e.g., a car, scooter, motorcycle, bicycle) and one or more courier devices 110 that can be associated with one or more couriers. In some examples, the one or more couriers are humans. In some examples, the courier can be non-human (e.g., vehicle, autonomous vehicle, autonomous robot). The one or more couriers and the one or more courier devices 110 (e.g., an onboard tablet, a mobile device of a courier) can be associated with the one or more vehicles 105A-D. The courier device(s) 110 can include a software application 112 associated with the food delivery service entity, which can run on the courier device(s) 110. The system 100 can include one or more merchants 115. The merchants 115 can receive data indicative of a food delivery service request from a user 120. For example, the user 120 can submit a request through a user device 125 associated with the user (e.g., via a software application such as application 127). A network system 130 can comprise a computing system associated with a service entity that can facilitate a request for services from user 120. An operations computing system 135 associated with the food delivery service entity can facilitate a request for services from user 120. For example, the user 120 can submit a food delivery request through a user device 125 associated with the user 120 (e.g., via a software application such as application 127). Operations computing system 135 can receive a food delivery service request for an order request 137 from a user device 125. The operations computing system 135 can send data indicative of order request 137 to a merchant device 140 associated with a merchant 115A (e.g., via a software application such as application 142).

The operations computing system 135 can receive data indicative of a merchant 115A accepting a food preparation request (e.g., food being prepared, estimated preparation time). The operations computing system 135 can send a request to a courier device 110 associated with the courier to complete the order request 137 (e.g., via application 112). The network system 130 can include geozones model 145 and/or a merchant ranking model 150. In some instances, the geozones model 145 and merchant ranking model 150 can be the same model. The geozones model 145 can include data indicative of merchants 145A. The geozones model 145 can include an isochrones model 145B. The merchant ranking model 150 can include merchant data 150A indicative of merchants. The merchant ranking model 150 can include a ranking model 150B.

The network system 130 can include a data repository 155. The data repository 155 can include user data 155A (e.g., data associated with user 120), historical data 155B (e.g., data associated with user 120, data associated with merchant(s) 115, data associated with couriers), merchant-specific data 155C (e.g., real-time data associated with merchants 115), and/or any other relevant data (e.g., system-level data associated with a plurality of users, expected demand, etc.).

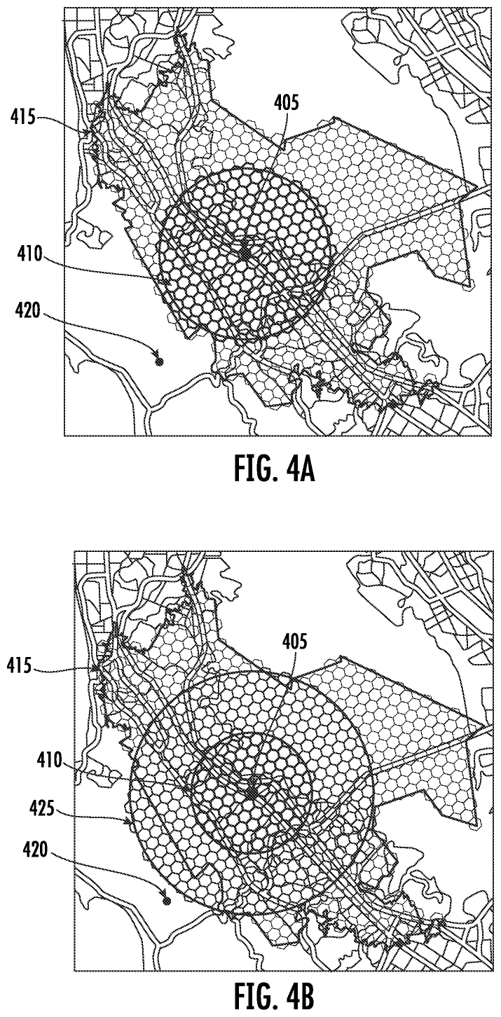

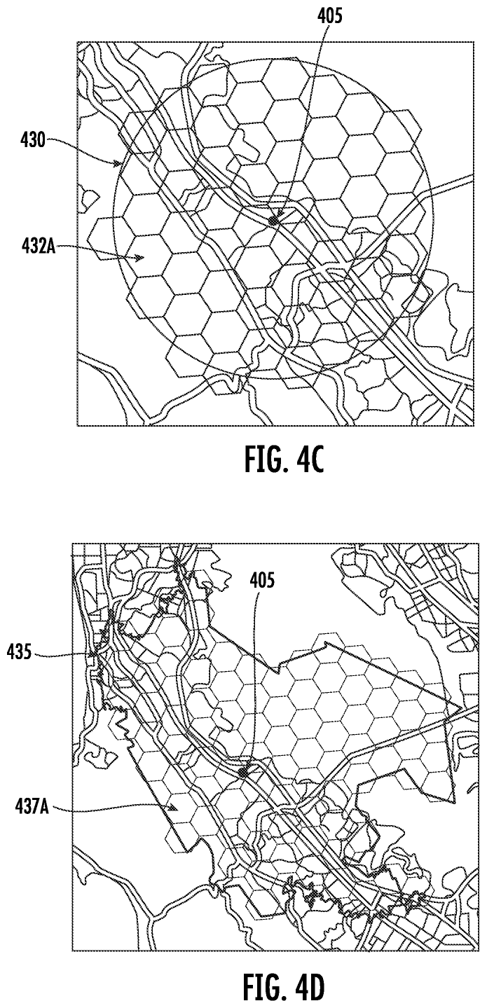

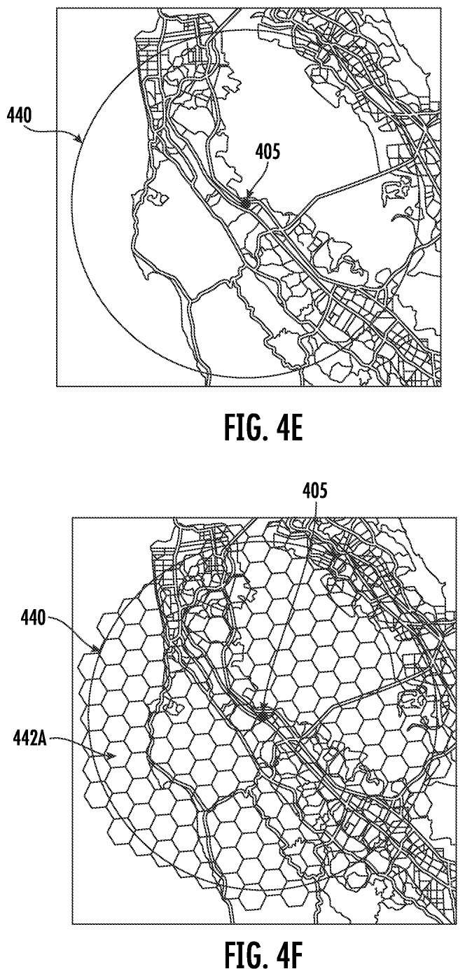

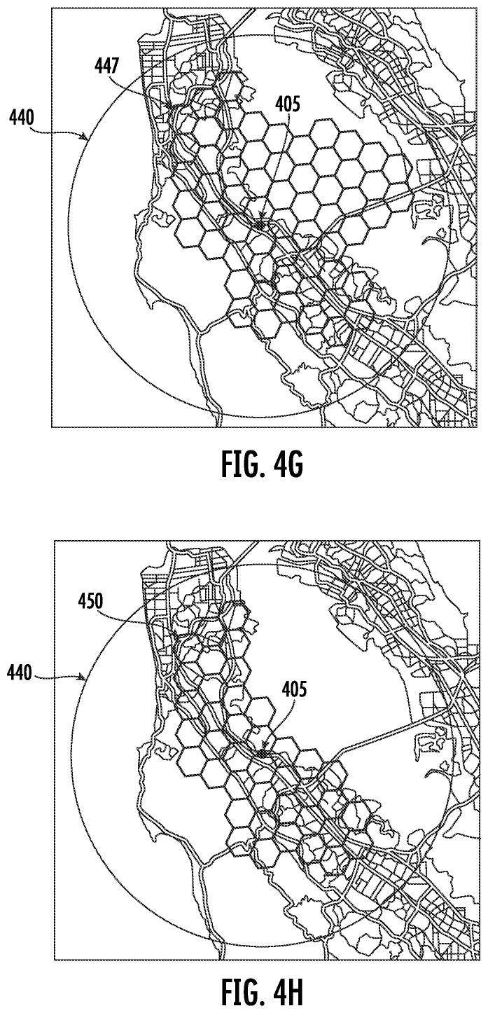

The geozones model 145 can generate one or more geozones using the merchants 145A and isochrones model 145B. For example, the operations computing system 135 can obtain data indicative of a merchant location (e.g., associated with merchants 145A). In response to obtaining data indicative of a merchant location, estimated travel time and/or other intent signals. The isochrones model 145B can generate a geozone (e.g., delivery zone for each merchant 145A). In some implementations, the isochrones model 145B can obtain intent signal data. In response to obtaining the signal data, the system (e.g., operations computing system 135) can determine an initial delivery zone dimension (e.g., an initial radius). The system can generate an initial delivery zone (e.g., an initial radial delivery zone larger than an expected isochrone for a specified travel time). The system can divide the initial delivery zone into sub-zones. The sub-zones can be in any polygon shape (e.g., a hexagon). For each respective sub-zone within the initial delivery zone, the system can use the isochrones model 145B to determine an expected travel time from the merchant location to the respective sub-zone. The system can use the isochrones model 145B to filter the sub-zones based on filtering criteria. In some embodiments, the filtering criteria can include a threshold time between the respective sub-zone and the merchant. The generation and filtering of sub-zones will be discussed further relating to FIGS. 4A-4C.

The geozones model 145 and/or merchant ranking model 150 can use data from the data repository 155 to surface one or more ranked merchants for display on a user device 125 (e.g., via application 127). The operations computing system 135 can receive data indicative of an order request 137 from a user device 125 (e.g., via application 127) for an order. The operations computing system 135 can generate and/or retrieve geozones associated with one or more candidate merchants (e.g., from the geozones model 145). The operations computing system 135 can determine a user location (e.g., associated with user 120 and/or user device 125). The operations computing system 135 can determine if the user location is within a sub-zone associated with a merchant geozone associated with a plurality of respective merchants. The merchant ranking model 150 can rank the plurality of respective merchants based on merchant data 150A and a ranking model 150B.

The operations computing system can generate data indicative of the order request 137 (e.g., estimated time of departure, estimated time of arrival, estimated preparation time, real-time updates on order preparation, real-time updates on order location). The operations computing system 135 can provide data for display on a user device 125 (e.g., via application 127) indicative of updates on the order request 137. For example, an update can include an update about what stage of delivery the primary order is in (e.g., preparation, pick-up by courier, courier in route, approaching delivery, delivered).

An operations computing system 135 associated with the service entity can receive an order request 137 from the user device 125. The operations computing system 135 can send a request to a courier device 110 associated with a courier (e.g., via a software application 112) for the courier to perform the requested primary order request service. The courier can be associated with the vehicle (e.g., vehicle 105A-D).

The operations computing system can communicate data indicative of the food delivery service assignment to a courier (e.g., a human courier, an autonomous vehicle courier, an autonomous robot courier). For instance, the operations computing system 135 can send a request to the courier device 110 of the courier. The request (e.g., for the courier to accept the food delivery service assignment) can be communicated to the courier via the software application 112 running on the courier device 110 associated with the courier. Additionally, or alternatively, the operations computing system 135 can send a request to a courier device(s) 110 (e.g., a tablet stored onboard the vehicle) of at least one of vehicles 105A-D. The request (for the courier to accept the food delivery service assignment) can be communicated to the courier via the software application 112 running on a courier device 110. The courier can provide user input to the courier device 110 (e.g., via the software application 112) to accept or decline the vehicle service assignment. In some examples, user input can be provided directly into a service application. Additionally, or alternatively, user input can be provided via an application programing interface (API) and/or a third-party application. Data indicative of the acceptance or rejection of the request can be provided to the operations computing system 135.

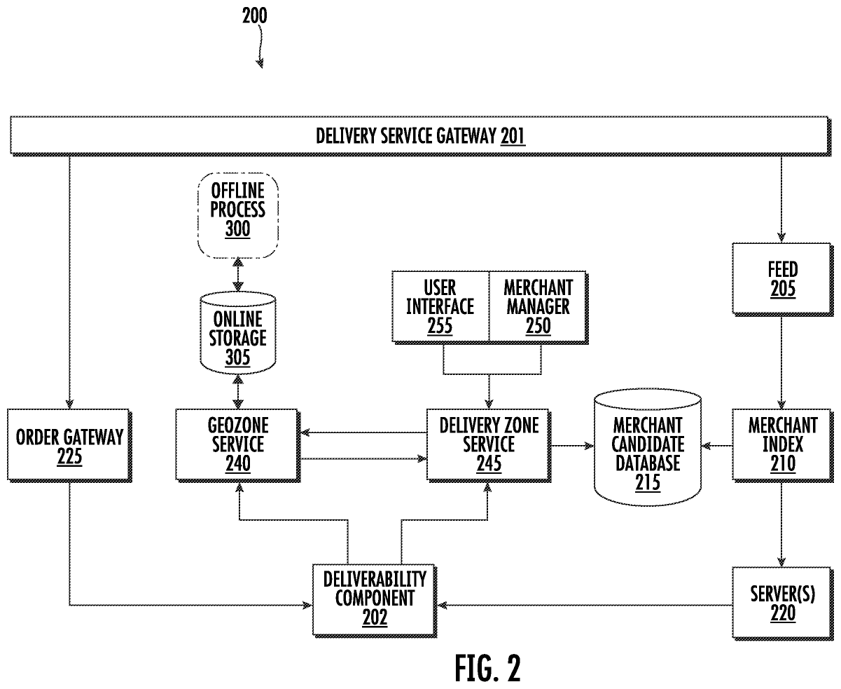

The network system 130 can include a plurality of potential system architecture designs. FIG. 2 depicts an example system architecture 200 associated with a process flow for fulfilling an order request according to aspects of the present disclosure. The architecture can include a delivery service gateway 201 that receives data indicative of a request for delivery service from a user device (e.g., user device 125, client device). Upon receipt of the data indicative of a request for delivery service, the system can send a request to a feed component 205 and/or an order gateway 225. Order gateway 225 can communicate directly with deliverability component 202. Feed component 205 can generate a feed for display on a user device comprising one or more menu items and/or merchant selection options. The merchant selection options and/or menu items can be stored in merchant index 210. Merchant index 210 can retrieve one or more candidate merchants from merchant candidate database 215. Merchant index 210 can communicate with one or more servers 220 to determine a rank for each respective merchant of the one or more candidate merchants. The servers 220 can determine a rank for each merchant based at least in part on the deliverability of each merchant which can be determined by the deliverability component 202. The deliverability component 202 can determine deliverability based at least in part on geozones stored in geozone service 240 (e.g., geozones associated with each merchant) and delivery zone service 245 (e.g., associated with each merchant). Geozone service 240 can be generated via offline process 300 and stored in online storage 305. Delivery zone service 245 can be populated based in part on merchant manager 250. Merchant manager 250 can include a user interface 255 which can be configured to obtain user input via selectable elements. The user input can be obtained by a user associated with the service provider to manage merchants (e.g., via merchant manager 250).

The deliverability component 202 can be used to determine if a menu item associated with a merchant (e.g., one of merchants 115) is deliverable to a user (e.g., user 120). A service provider (e.g., delivery service provider associated with operations computing system 135) can set parameters used to determine the deliverability of a menu item associated with a merchant. The deliverability component 202 can be used to confirm deliverability at various points in the merchant selection, ranking, and order processing processes.

The right portion of system architecture 200 depicts the process of a service application launching and generation and/or display of a feed comprising menu item(s) and/or merchant selection option(s) to be provided for display via a user device (e.g., user device 125). For example, feed component 205 can handle feed generation and ranking based on the receipt of data indicative of an application launch on a user device (e.g., application 127 on user device 125). The feed component 205 can relay information to a merchant index 210 which can include proximate deliverable merchants based on a location associated with a delivery service request (e.g., a user location). Merchant index 210 can retrieve one or more candidate merchants from a merchant candidate database 215.

The merchant candidate database 215 can call to one or more servers 220 which contain metadata for the one or more candidate merchants. The one or more servers 220 can relay the metadata for the one or more candidate merchants to the merchant index 210. The merchant index 210 can communicate with the one or more servers 220 to determine a rank for each respective merchant of the one or more merchants. In some instances, the one or more servers 220 can communicate with the deliverability component 202. In some embodiments, it can be determined that a merchant is undeliverable by the deliverability component 202. In such instances, the undeliverable merchant can be ranked at the bottom or excluded from a list of one or more candidate merchants.

Turning to the left side of system architecture 200, the system can obtain data indicative of an order checkout (e.g., via delivery service gateway 201). For example, the system can obtain data indicative of user input via a user interface of a user device (e.g., user device 125). The user input can be indicative of user selection of a “checkout” option following the creation (and/or filling) of a cart. The checkout function can be facilitated via the order gateway 225. Upon receipt of user input indicative of selection of a “checkout” option, the system can perform a checking operation to confirm the deliverability of the one or more merchants associated with the cart based on data obtained from the deliverability component 202. In some embodiments data can be obtained that is indicative of a user launching a delivery service application (e.g., application 127). The system can provide for display a selectable user interface element indicating that a user can select the user interface element to “reorder” a past menu item. Upon user selection of “reorder” a past menu item, the system can check with the deliverability component 202 to determine that the merchant associated with the reordered menu item is a deliverable merchant (e.g., for the current time, current location of a user, current courier supply).

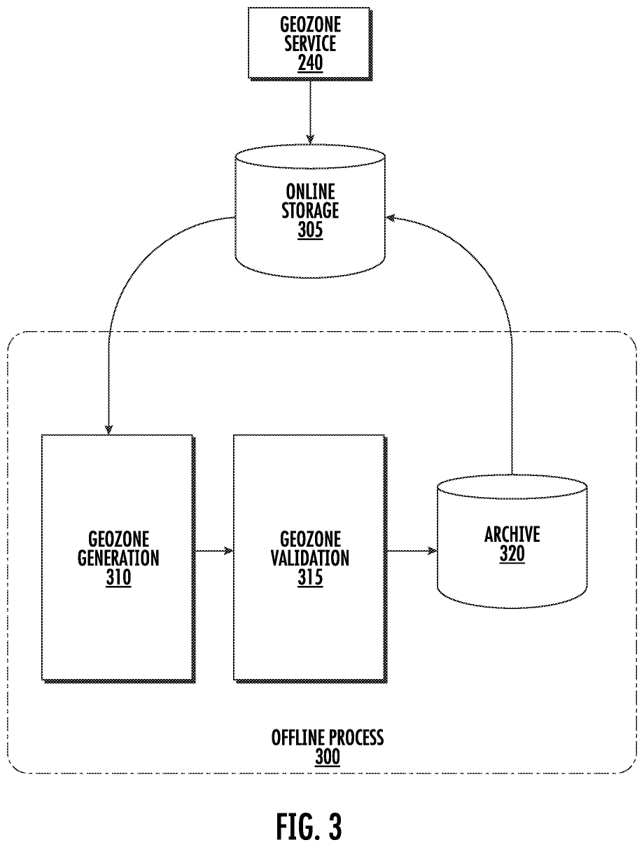

The system can include an offline process 300 which is discussed further in regard to FIG. 3. The offline process can be used to generate isochrones for each respective merchant of one or more merchants associated with a particular geographic area. The offline process 300 can generate a set of polygons (e.g., hexagons, squares, triangles, pentagons, heptagons, octagons) associated with each respective merchant. The set of polygons associated with the merchant can be considered the merchant's geozone. The geozone can be stored in geozone service 240. Geozone service 240 can include merchant's geozones which can be used as a source of truth for delivery zone service 245. Geozone service 240 can be a generic service used to store zones that represent a geographical area in the real world. These geozones can be associated with a variety of merchant and services (e.g., restaurants, freight delivery services, other service providers).

The system can include merchant manager 250 which can have an associated user interface 255. Merchant manager 250 can surface a plurality of merchants (e.g., restaurants) via the user interface 255. The user interface 255 can comprise selectable elements used for managing the candidate merchants (e.g., via input from a user associated with a delivery service and/or service provider).

FIG. 3 depicts the offline process 300 briefly discussed with regard to FIG. 2. Geozone service 240 can obtain geozones for candidate merchants from online storage 305. Geozones can be generated via offline process 300. For example, a plurality of geozones can be generated for a merchant for a plurality of times during a day. Geozone generation 310 can average these geozones to determine a geozone for a merchant that will result in consistent availability of a merchant throughout a day (e.g., merchants available at lunch are generally also available at dinner). Geozones can be generated using a travel time between a merchant and a sub-zone.

In some implementations, the geozones can vary based on intent signals. For example, intent signals can include demand, courier supply, etc. If a courier supply is particularly large for a given time, one or more expanded geozones can be generated (and/or retrieved) to expand the area in which a merchant is deliverable. Geozone generation and deliverability determination can be determined in any reasonable manner, including any implementation, embodiment, and/or aspect disclosed in this description. See FIGS. 4A-4H for further illustration of geozone generation. Geozones can be generated upon a merchant's onboarding to a service provider platform.

In some embodiments, geozones can be generated on a regular interval or can be generated in response to one or more triggers. For example, geozones can be regenerated hourly, daily, weekly, monthly. In some examples, geozones can be generated in response to a trigger. For example, a trigger can include a new traffic pattern and/or an intent signal. A new traffic pattern can be associated with a road opening, road closure, new traffic light, etc. An intent signal can include a supply condition, weather condition, etc. For example, during warmer months (e.g., the summer) more couriers may be available and/or willing to perform delivery service requests. In response, geozones may be expanded to service a larger area associated with a longer travel time between a merchant and a particular sub-zone of the geozone. Additionally, or alternatively, in a time with greater traffic and/or or worse weather, there can be an undersupply of couriers. In an instance of undersupply of couriers, geozones may be reduced to service a smaller area associated with shorter travel time between a merchant and a particular sub-zone of the geozone. Increasing and/or decreasing the area of the geozone can result in more efficient allocation of resources (e.g., via courier placement, ranking merchants and displaying those with highest likelihood of obtaining user selection).

Geozones can be generated based on intent signals and/or demand signals. Demand signals can be associated with cuisine types, diversity of cuisine options for a particular delivery area, data indicative of users searching for a particular cuisine, data indicative of user searching for a particular merchant, a group of users located above a threshold distance from any merchant associated with a specific cuisine type, etc. Intent signals can include signals obtained from a shared database associated with a service provider and other services provided by the provider (e.g., rideshare service, alternative delivery services, etc.). For example, the system can obtain data indicative of a rideshare history associated with a user being dropped off and/or picked up from a particular restaurant. In response, the system can expand a geozone to include a sub-zone associated with user's location even though the sub-zone would otherwise be excluded from a strictly travel time based geozone model. In some embodiments, the system can determine that geozone generation based on intent and/or demand signals can result in relocation of courier supply. This can result in an increase in opportunities to batch orders, create opportunities for add-on orders, and/or affect the generation of isochrones for merchants based on expected reallocation of courier supply.

The size of a geozone being increased and/or decreased based on intent signals and/or demand signals can be determined in a variety of ways. For example, an increase and/or decrease in geozone size can be made by adjusting a travel time threshold, adjusting a percentage of sub-zones (e.g., polygons, hexagons), use of an algorithm to determine an adjustment based on weighting signals, etc. For example, based on the number of positive demand signals, an increased travel time threshold could be determined to be acceptable. For example, if there are five restaurants within 30 minutes travel time of a user location associated with Italian cuisine, a sixth Italian restaurant located 40 minutes away from the user location may not be surfaced. However, if there are no Chinese restaurants within 30 minutes of a user location, but there are intent and/or demand signals that indicate a user in that location is likely to initiate and order from a Chinese cuisine restaurant, it could be determined that the travel time threshold should be adjusted to 35 or 40 minutes.

Following geozone generation 310, the geozones can be passed to geozone validation 315. At geozone validation 315, the geozones can be analyzed (e.g., via an automated process, via human validation) to determine discrepancies. For example, traffic data can be noisy and result in one or more holes within a geozone that are filtered out due to being above a threshold travel time away from the merchant. Geozone validation 315 can determine that these holes should not exist and update the geozone(s) accordingly. A smoothing strategy can be used to fill in these holes. Additionally, or alternatively, geozone validation 315 can include a comparison of a newly generated geozone with one or more previously generated geozones. Additionally, or alternatively, the geozones can be validated via a comparison with user generated geozones.

In some examples, the system can determine that the validation of a geozone has failed. In this instance the validation pipeline is paused. The system can determine if there are any holes within the geozone, the system can determine if there are differences between a prior geozone and the newly generated geozone. They system can determine that the differences between a prior geozone and the newly generated geozone are above a threshold. In response to failing validation, the system can revert to a prior geozone until the new geozone can be validated. In response to a geozone being successfully validated, the system can add the geozone to archive 320.

As geozones for merchants are generated and validated, they can be stored in archive 320. Archive 320 can include geozones associated with merchants and an identifier of origination. An identifier of origination can include a day and/or time stamp of generation. The archive 320 can include historical geozones (e.g., previously generated geozones, prior geozones) as well as the most recently generated geozones for each respective merchant. The system can extract the most up to date geozones from archive 320 and send data indicative of the most up-to-date geozones to be stored in online storage 305. Geozone service 240 can access online storage 305 to obtain data indicative of geozones for the candidate merchants. The system can use geozone service 240 and this data as a validation tool in conjunction with delivery zone service 245 to determine which candidate merchants should be ranked and displayed via a feed displayed on a user device. The system can obtain data indicative of a geozone associated with a merchant. In response to obtaining the data, the system can update a merchant profile which can be used to adjust search clusters associated with merchants for delivery orders (e.g., which can affect the selection and/or ranking of merchants).

By generating geozones comprising a plurality of sub-zones that are within a particular threshold of a merchant location, real-time processing associated with service requests can be decreased. For example, when a user launches a service application, the service application can determine what sub-zone is associated with the user's current location (and/or location data obtained via user input). The sub-zone can be associated with a plurality of merchant geozones. The system can rank merchants with geozones comprising the sub-zone associated with the user location and filter out merchants with geozones that do not include the sub-zone associated with the user location. This can decrease in processing by the system because the system does not need to calculate a travel time between the merchant and user location for each potential candidate merchant. Moreover, by generating the geozones in an offline process, the payload in the service application can be reduced by offloading and storing this data offline and making only necessary portions available online.

Each merchant can have a plurality of geozones associated with the merchant. For example, a first merchant can have a geozone associated with 15-minute, 30-minute, and 45-minute travel time from the merchant location. Based on which geozone a user's associated sub-zone falls within, requirements for delivery service can change. For example, delivery of an item that is further away could result in increased delivery fees, larger basket size requirements, affect which items and/or merchants are displayed to a user as a candidate merchant. Additionally, or alternatively, the available geozones can be adjusted based on courier supply, user demand, and/or restaurant specific characteristics. Restaurant specific characteristics can include at least one of cuisine type, frequency of order (e.g., how often users from a geographic area order from a specific restaurant), and/or frequency of searches (e.g., how often users search for the restaurant).

FIGS. 4A-4D depict various examples of radial delivery zones and geozone generation. FIG. 4A depicts an example geographic area 400, a merchant location 405, a first radial delivery zone 410 associated with a maximum travel time of 15 minutes, a geozone 415 generated based on a 15-minute isochrone, and a point 420 located 40 minutes travel time from the merchant location 405. FIG. 4B depicts example geographic area 400 including merchant location 405, first radial delivery zone 410, geozone 415, the point 420, and second radial delivery zone 425 which comprises a radius two times the radius of first radial delivery zone 410. As depicted in FIGS. 4A and 4B, you can see the drawbacks of using strictly radial delivery zones and expanding zones based on a multiple of the radial zone.

For example, as shown in FIG. 4A, first radial delivery zone 410 is associated with the largest radius that can ensure that any sub-zone within the radius will result in a travel time of 15 minutes or less. Geozone 415 shows an area of sub-zones which can be reached within a travel time of 15 minutes or less. If, however, a radius were based on the further distance that is associated with a travel time of 15 minutes (e.g., across the bridge), then the radial delivery zone would encompass point 420 which would take 40 minutes of travel time to reach.

FIG. 4B depicts the same set up as FIG. 4A, but additionally includes a second radial delivery zone 425 with a radius two times the length of first radial delivery zone 410's radius. FIG. 4B shows that second radial delivery zone 425 includes a portion of sub-zones that are above 15 minutes travel time from the merchant location 405 while also not including a large portion of sub-zones that are included in the geozone 415 which is generated using a 15-minute isochrone from merchant location 405. The travel time can be generated using service provider data. The travel time can be determined based on distance traveled, traffic patterns, modalities (pedestrian, bike, scooter, car, aerial vehicle, etc.), etc.

FIGS. 4C and 4D further illustrate the increased area that can be labeled as deliverable for a merchant by using geozones generated using isochrones compared to radial delivery zones. As seen in FIG. 4C, a radial delivery zone 430 can be associated with a 15-minute maximum travel time from merchant location 405. The radial delivery zone 430 can be populated with a plurality of sub-zones (e.g., hex 7 hexagons, hexagon 432A). As depicted in FIG. 4C, there are 54 hexagons (e.g., 54 sub-zones) within radial delivery zone 430. FIG. 4D depicts an isochrone based geozone 435 associated with distances associated with a 15-minute maximum travel time (and/or 6-mile radius) from merchant location 405. Geozone 435 can be populated with a plurality of sub-zones (e.g., hex 7 hexagons, hexagon 437A). As depicted in FIG. 4D, there are 89 hexagons (e.g., 89 sub-zones) within geozone 435. Thus, a delivery zone based on isochrones can service more sub-zones than a delivery zone based on a radius associated with a maximum travel time.

FIGS. 4E-4H depict example steps of geozone generation according to example aspects of the present disclosure. FIG. 4E depicts an example geographic area containing merchant location 405. The system can obtain data indicative of merchant location 405. The system can generate an initial delivery zone 440 around merchant location 405. In some embodiments, the initial delivery zone 440 can be a circle with a predetermined radius. For example, the predetermined radius can be associated with a distance far greater than a maximum allowed travel distance.

Turning to FIG. 4F, the system can populate the initial delivery zone 440 with a plurality of sub-zones 442A. The system can generate a plurality of polygons that fill an area of the radial delivery zone. In some embodiments the plurality of polygons can include a plurality of hexagons. For example, as depicted in FIG. 4F, the sub-zones can be hexagon in shape. The system can determine an estimated travel time from the merchant location 405 to each respective sub-zone (e.g., sub-zone 442A). The system can compare the estimated travel time for each respective sub-zone to a threshold travel time. In some implementations, the system can filter the sub-zones based at least in part on: (i) the comparing of the estimated travel time for each respective sub-zone to the threshold travel time, or (ii) one or more geographical boundaries.

In some embodiments, the system can filter the sub-zones based on comparing the estimated travel time for each respective sub-zone to the threshold travel time. By way of example, FIG. 4G depicts sub-zones filtered to only show sub-zones associated with a travel time below a threshold travel time of 15 minutes. This grouping of sub-zones can represent a geozone for the merchant associated with merchant location 405.

Additionally, or alternatively, the system can filter the sub-zones based in part on one or more geographical boundaries. In some implementations, the one or more geographic boundaries can include at least one of: (i) a body of water, (ii) a mountain range, (iii) a bridge, and/or (iv) a tunnel. By way of example, FIG. 4H depicts sub-zones that have been filtered to include sub-zones that are not over the body of water and/or that have a travel time below the threshold travel time of 15 minutes. This grouping of sub-zones can represent a geozone for the merchant associated with merchant location 405.

Geozones can be generated for a plurality of merchants as described within. The system can store the geozones in a geozone data store. In some implementations, the system can utilize the stored geozones in selecting and/or ranking merchants to be displayed to a user via a user interface. The system can use these geozones in facilitating fulfillment of a delivery service for a user.

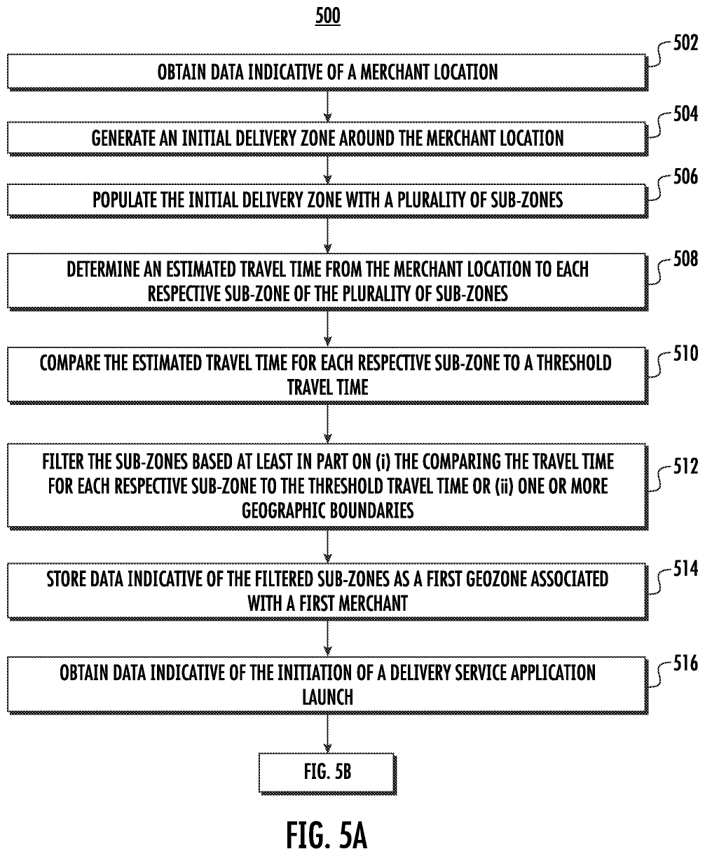

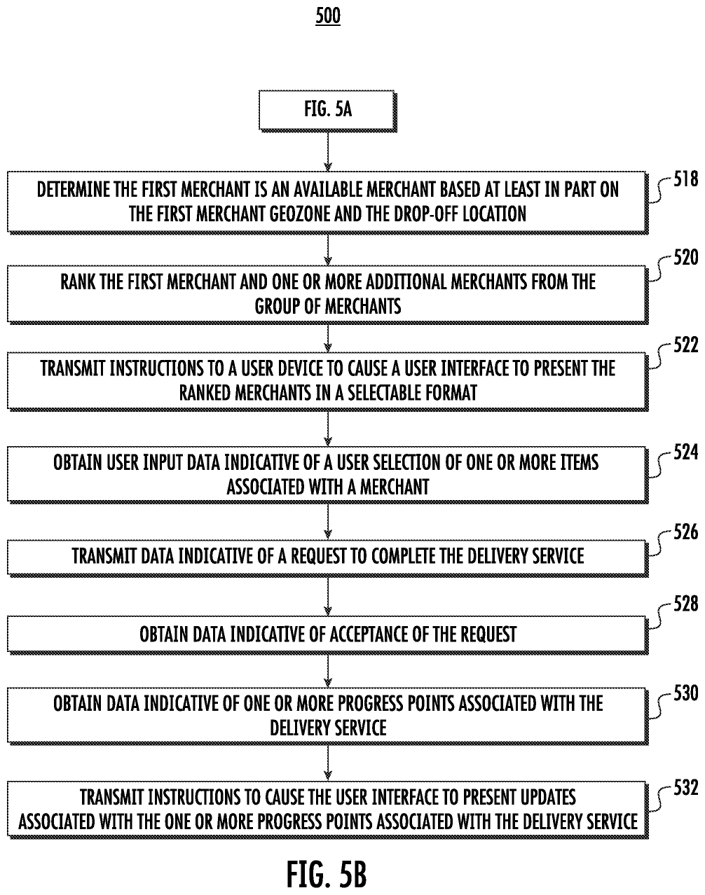

FIGS. 5A and 5B depict a flowchart diagram of an example method for generating and utilizing isochrone based geozones for ranking and displaying candidate merchants for a delivery service. One or more portion(s) of the method 500 can be implemented by one or more computing devices such as, for example, the computing devices/systems described in FIGS. 1, 2, 3, 6, and 7. Moreover, one or more portion(s) of the method 500 can be implemented as an algorithm on the hardware components of the device(s) described herein (e.g., as in FIGS. 1, 2, 3, 6, and 7). For example, a computing system can include one or more processors and one or more non-transitory, computer-readable media storing instructions that are executable by the one or more processors to cause the computing system to perform operations, the operations including one or more of the operations/portions of method 500. FIGS. 5A and 5B depict elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure

At (502), method 500 can include obtaining data indicative of a merchant location. For instance, a computing system (e.g., an operations computing system associated with a service entity) can obtain user data associated with a merchant location. As described here, a merchant location can be automatically determined based on data associated with a merchant device. Additionally, or alternatively, a merchant location can be obtained via user input (e.g., by a user associated with a merchant, a user associated with a mapping service).

At (504), method 500 can include generating a radial delivery zone around the merchant location. For instance, a computing system (e.g., an operations computing system associated with a service entity) can generate a radial delivery zone around the merchant location. As described herein, the radial delivery zone can comprise a circle with a specified radius. The center of the circle can represent the merchant location.

At (506), method 500 can include populating the radial delivery zone with a plurality of sub-zones. For instance, a computing system (e.g., an operations computing system associated with a service entity) can populate the radial delivery zone with a plurality of sub-zones. As described herein, the system can generate a plurality of polygons that fill an area of the radial delivery zone. In some embodiments the plurality of polygons can include a plurality of hexagons.

At (508), method 500 can include determining an estimated travel time from the merchant location to each respective sub-zone of the plurality of sub-zones. For instance, a computing system (e.g., an operations computing system associated with a service entity) can determine an estimated travel time from the merchant location to each respective sub-zone of the plurality of sub-zones. As described herein, determining the estimated travel time from the merchant location to each respective sub-zone of the plurality of sub-zones can include determining a travel time for a plurality of modalities including at least one of: pedestrian, bicycle, electric scooter, or car.

By way of example, the system can determine a geozone for each respective merchant of a plurality of merchants. The system can determine a plurality of filtered sub-zones representing sub-zones with travel times between a respective merchant location and the respective sub-zone equal to or less than the threshold travel time. The system can associate the plurality of filtered sub-zones with the respective merchant. The system can store the respective geozone comprising the plurality of filtered sub-zones associated with the respective merchant.

At (510), method 500 can include comparing the travel time for each respective sub-zone to a threshold travel time. For instance, a computing system (e.g., an operations computing system associated with a service entity) can compare the estimated travel time for each respective sub-zone to a threshold travel time. As described herein, the threshold travel time can be determined based on at least one of courier supply, customer demand, or restaurant specific characteristics. In some embodiments, the restaurant specific characteristics include at least one of cuisine type, frequency of orders, or frequency of searches.

At (512), method 500 can include filtering the sub-zones based at least in part on (i) the comparing the travel time for each respective sub-zone to the threshold travel time or (ii) one or more geographic boundaries. For instance, a computing system (e.g., an operations computing system associated with a service entity) can filter the sub-zones based at least in part on: (i) the comparing of the estimated travel time for each respective sub-zone to the threshold travel time; or (ii) one or more geographic boundaries. In some embodiments, filtering the sub-zones based at least in part on the comparing of the estimated travel time for each respective sub-zone to the threshold travel time. By way of example, the system can compare a first travel time associated with a first sub-zone to the threshold travel time. In some embodiments, the system can determine the first travel time exceeds the threshold travel time. In some implementations, the system can remove the first sub-zone based on the determination that the first travel time exceeds the threshold travel time. In some embodiment, the one or more geographic boundaries can include at least one of: (i) a body of water, (ii) a mountain range, (iii) a bridge, or (iv) a tunnel.

As described herein, filtering the sub-zones based at least in part on the comparing of the estimated travel time for each respective sub-zone to the threshold travel time can include comparing a first travel time associated with a first sub-zone to the threshold travel time. For example, the system can determine the first travel time is less than or equal to the threshold travel time. The system can maintain the sub-zone based on the determination that the first travel time is less than or equal to the threshold travel time. By way of example, the system can determine a first geozone for a first merchant. For instance, a computing system (e.g., an operations computing system associated with a service entity) can determine a first geozone for a first merchant. As described herein, the system can determine a plurality of filtered sub-zones representing sub-zones with travel times between a first merchant location and the respective sub-zone equal to or less than the threshold travel time. The system can associate the plurality of filtered sub-zones with the first merchant. In some implementations, the system can store the first geozone comprising the plurality of filtered sub-zones associated with the first merchant.

In some implementations, method 500 can include a smoothing the geozone for each respective merchant of a plurality of merchants. For example, smoothing can include spatial smoothing and/or time-based smoothing. Smoothing can include averaging data points with neighbors to reduce noise. For example, the method can include comparing neighboring sub-zones and generating an outline of a geozone comprising the filtered sub-zones. The outline of the geozone can include an outline that modifies individual sub-zones to reduce points that are higher (e.g., greater distance, greater time) and/or increasing points that are lower (e.g., lesser distance, lesser time). In this way the geozone can include a smoothed outline.

At (514), method 500 can include storing data indicative of the filtered sub-zones as a first geozone associated with a first merchant. For instance, a computing system (e.g., an operations computing system associated with a service entity) can store data indicative of the filtered sub-zones as a first geozone associated with a first merchant associated with the merchant location. As described herein, the first geozone can be stored in a data store (e.g., database, online storage 305, archive 320).

At (516), method 500 can include obtaining data indicative of the initiation of a delivery service application launch. For instance, a computing system (e.g., an operations computing system associated with a service entity) can obtain data indicative of initiation of a delivery service application launch, wherein the data comprises at least a drop-off location. As described herein, the drop-off location can include a user-input drop-off location or a predicted drop-off location

At (518), method 500 can include determining the first merchant is an available merchant based at least in part on the first merchant geozone and the drop-off location. For instance, a computing system (e.g., an operations computing system associated with a service entity) can determine the first merchant is an available merchant based at least in part on the first geozone and the drop-off location.

At (520), method 500 can include ranking the first merchant and one or more additional merchants from the group of merchants. For instance, a computing system (e.g., an operations computing system associated with a service entity) can rank the first merchant and one or more additional merchants from a group of merchants. As described herein, the system can determine a drop-off location associated with a service request. The system can determine a sub-zone is associated with the drop-off location (e.g., the drop-off location is located within a sub-zone). In some implementations, each sub-zone can have a unique identifier. The system can use the unique identifier to determine which sub-zones are associated with each merchant geozone. This can be used by the system to determine a user location and/or drop-off location, the sub-zone associated with the user location, and the geozones associated with the sub-zone. Thus, based on whether a drop-off location and/or use location is located within a geozone of a merchant can factor into the ranking of the merchants by the delivery service. For example, the system can obtain data indicative of a geozone associated with the first merchant. The system can determine that the geozone associated with the first merchant does not include a sub-zone associated with the drop-off location. In response to determining that the geozone associated with the first merchant does not include a sub-zone associated with the drop-off location, the system can rank the first merchant as at least one of (i) no rank or (ii) bottom rank.

At (522), method 500 can include transmitting instructions to a user device to cause a user interface to present the ranked merchants in in a selectable format. For instance, a computing system (e.g., an operations computing system associated with a service entity) can transmit instructions to a user device to cause a user interface to present the ranked merchants in a selectable format. As described herein, the system can update a user interface to present the ranked merchants in a selectable format. For example, a list of menu items and merchants can be displayed on a user device

At (524), method 500 can include obtaining user input data indicative of a user selection of one or more items associated with a merchant. For instance, a computing system (e.g., an operations computing system associated with a service entity) can obtain user input data indicative of selection one or more items associated with a merchant. As described herein, a user can select one or more items to build a cart. Following the user providing input indicative of completion of an order, the system can facilitate preparation, pick-up, and/or delivery of the one or more menu items associated with the order.

At (526), method 500 can include transmitting data indicative of a request to complete the delivery service. For instance, a computing system (e.g., an operations computing system associated with a service entity) can transmit, to a courier device, data indicative of a request to complete the delivery service. By way of example, the data indicative of a request to complete the delivery service can comprise a notification on a courier device associated with a courier providing the courier with options to accept or decline the service request. By way of example, the computing system can facilitate a delivery service of the one or more items from the merchant location to the drop-off location.

At (528), method 500 can include obtaining data indicative of acceptance of the request. For instance, a computing system (e.g., an operations computing system associated with a service entity) can obtain data indicative of acceptance of the request. By way of example, a courier can select an “accept” option via a selectable user interface element on a user device. The computing system can receive data indicative of the user selection of the accept option.

At (530), method 500 can include obtaining data indicative of one or more progress points associated with the delivery service. For instance, a computing system (e.g., an operations computing system associated with a service entity) can obtain data indicative of one or more progress points associated with the delivery service. By way of example, the computing system can obtain data indicative of the courier arriving and/or departing from various progress points (e.g., in route to pick-up, at pick-up location, in route to drop-off, approaching drop-off location).

At (532), method 500 can include transmitting instructions to cause the user interface to present updates associated with the one or more progress points associated with the delivery service. For instance, a computing system (e.g., an operations computing system associated with a service entity) can transmit, to the user device, instructions to cause the user interface to present updates associated with the one or more progress points associated with the delivery service. By way of example, upon receipt of data indicative of the courier arriving at various progress points, the system can transmit instructions which cause the user interface of the user (e.g., consumer) to display the progress.

In an example embodiment, the operations can be focused on (502) to (514). For example, as described herein, the system can generate and store geozones associated with respective merchants.

In an example embodiment, the operations can be focused on (516) to (532). For example, as described herein, the system can use the stored geozones to select and rank merchants (and/or associated menu items) for user selection. The system can facilitate the fulfillment of a delivery request according to example embodiments of the present disclosure.

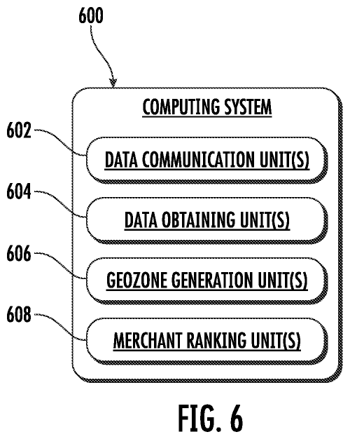

Various means can be configured to perform the methods and processes described herein. For example, FIG. 6 depicts an example system 600 that includes various means according to example embodiments of the present disclosure. The computing system 600 can be and/or otherwise include, for example, an operations computing system, etc. The computing system 600 can include data communication unit(s) 602, data obtaining unit(s) 604, geozone generation unit(s) 606, merchant ranking unit(s) 608, and/or other means for performing the operations and functions described herein. In some implementations, one or more of the units can be implemented separately. In some implementations, one or more units can be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), and/or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), and/or other suitable hardware.

The means can be programmed to perform one or more algorithm(s) for carrying out the operations and functions described herein. For instance, the means (e.g., data communication unit(s) 602) can be configured to communicate data indicative of a request for a courier to perform a delivery service associated with a delivery service request (e.g., a primary and/or add-on order request).

In addition, the means (e.g., data obtaining unit(s) 604) can be configured to obtain data associated with a delivery service request. For example, delivery service request can be indicative of a pick-up location, merchant, item, and/or drop-off location associated with a delivery service request. In addition, in some implementations, the means (e.g., the data obtaining unit(s) 604) can obtain data associated with one or more couriers, one or more merchants, and/or map data indicative of one or more geographic areas.

In addition, the means (e.g., geozone generation unit(s) 606) can be configured to generate one or more isochrone-based geozones for a plurality of merchants. For example, the geozones can be associated with a geographical area of sub-zones that can be reached from a merchant location within a threshold time. By way of example, the geozone generation can include processing of intent and demand signals associated with respective merchants.

In addition, the means (e.g., merchant ranking unit(s) 608) can be configured to determine a ranking of selected merchants for display on a user device. In addition, or alternatively, the selected merchants for display can be determined ranked based on contextual data and/or user data.

These described functions of the means are provided as examples and are not meant to be limiting. The means can be configured for performing any of the operations and functions described herein.

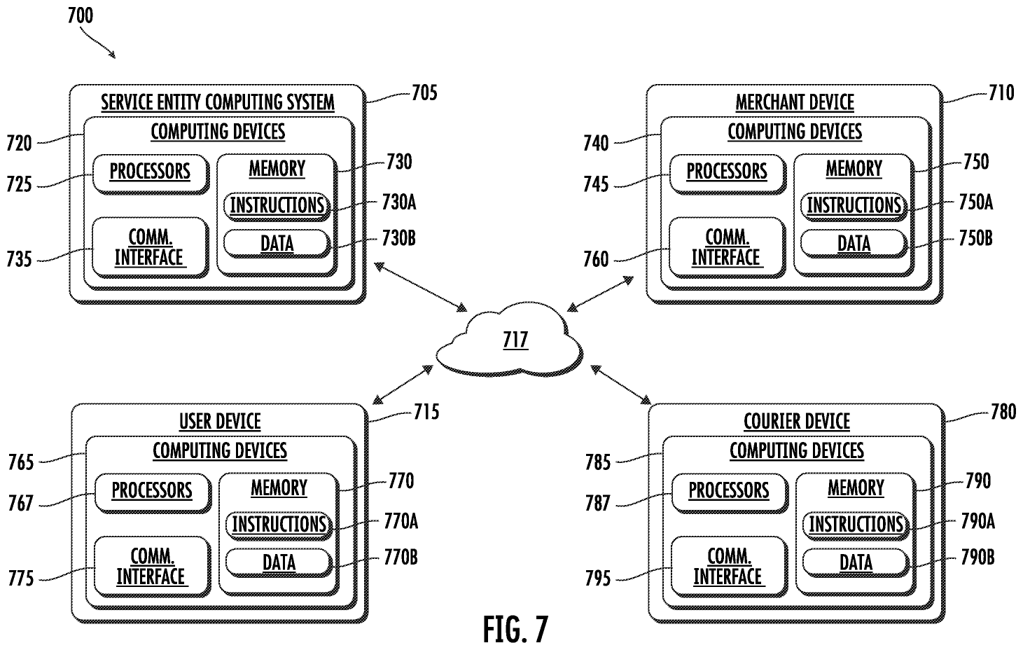

FIG. 7 depicts a block diagram of an example system 700 for implementing systems and methods according to example embodiments of the present disclosure. The example system 700 illustrated in FIG. 7 is provided as an example only. The components, systems, connections, and/or other aspects illustrated in FIG. 7 are optional and are provided as examples of what is possible, but not required, to implement the present disclosure. The example system 700 can include a service entity computing system 705 (e.g., that is associated with a delivery service entity and/or service provider). The example system 700 can include one or more merchant devices 710 (e.g., that is associated with a merchant). The example system 700 can include one or more user devices 715 (e.g., user device of the user, user device of the operator, user device of the vehicle). The example system 700 can include one or more courier devices 780 (e.g., a display device positioned on the exterior of a vehicle). One or more of the service entity computing system 705, the merchant device 710, the user device 715, or the courier device 780 can be communicatively coupled to one another over one or more communication network(s) 717. The networks 717 can correspond to any of the networks described herein.

The computing device(s) 720 of the service entity computing system 705 can include processor(s) 725 and a memory 730. The one or more processors 725 can be any suitable processing device (e.g., a processor core, a microprocessor, an ASIC, a FPGA, a controller, a microcontroller) and can be one processor or a plurality of processors that are operatively connected. The memory 730 can include one or more non-transitory computer-readable storage media, such as RAM, ROM, EEPROM, EPROM, one or more memory devices, flash memory devices, data registrar, etc., and combinations thereof.

The memory 730 can store information that can be accessed by the one or more processors 725. For example, the memory 730 (e.g., one or more non-transitory computer-readable storage mediums, memory devices) can include computer-readable instructions 730A that can be executed by the one or more processors 725. The instructions 730A can be software written in any suitable programming language or can be implemented in hardware. Additionally, or alternatively, the instructions 730A can be executed in logically and/or virtually separate threads on processor(s) 725.

For example, the memory 730 can store instructions 730A that when executed by the one or more processors 725 cause the one or more processors 725 (the service entity computing system 705) to perform operations such as any of the operations and functions of the computing system(s) (e.g., operations computing system) described herein (or for which the system(s) are configured), one or more of the operations and functions for communicating between the computing systems, one or more portions/operations of method 500, and/or one or more of the other operations and functions of the computing systems described herein.

The memory 730 can store data 730B that can be obtained (e.g., acquired, received, retrieved, accessed, created, stored). The data 730B can include, for example, any of the data/information described herein. In some implementations, the computing device(s) 720 can obtain data from one or more memories that are remote from the service entity computing system 705.

The computing device(s) 720 can also include a communication interface 735 used to communicate with one or more other system(s) remote from the service entity computing system 705, such as merchant device 710, user device 715, and/or courier device 780. The communication interface 735 can include any circuits, components, software, etc. for communicating via one or more networks (e.g., network(s) 717). The communication interface 735 can include, for example, one or more of a communications controller, receiver, transceiver, transmitter, port, conductors, software and/or hardware for communicating data.

The merchant device 710 can include one or more computing device(s) 740 that are remote from the service entity computing system 705, the user device 715, and the courier device 780. The computing device(s) 740 can include one or more processors 745 and a memory 750. The one or more processors 745 can be any suitable processing device (e.g., a processor core, a microprocessor, an ASIC, a FPGA, a controller, a microcontroller) and can be one processor or a plurality of processors that are operatively connected. The memory 750 can include one or more tangible, non-transitory computer-readable storage media, such as RAM, ROM, EEPROM, EPROM, one or more memory devices, flash memory devices, data registrar, etc., and combinations thereof.

The memory 750 can store information that can be accessed by the one or more processors 745. For example, the memory 750 (e.g., one or more tangible, non-transitory computer-readable storage media, one or more memory devices) can include computer-readable instructions 750A that can be executed by the one or more processors 745. The instructions 750A can be software written in any suitable programming language or can be implemented in hardware. Additionally, or alternatively, the instructions 750A can be executed in logically and/or virtually separate threads on processor(s) 745.

For example, the memory 750 can store instructions 750A that when executed by the one or more processors 745 cause the one or more processors 745 to perform operations such as any of the operations and functions of the computing system(s) (e.g., merchant server) described herein (or for which the system(s) are configured), one or more of the operations and functions for communicating between computing systems, one or more portions/operations of method 500, and/or one or more of the other operations and functions of the computing systems described herein. The memory 750 can store data 750B that can be obtained. The data 750B can include, for example, any of the data/information described herein.

The computing device(s) 740 can also include a communication interface 760 used to communicate with one or more system(s) that are remote from the merchant device 710. The communication interface 760 can include any circuits, components, software, etc. for communicating via one or more networks (e.g., network(s) 717). The communication interface 760 can include, for example, one or more of a communications controller, receiver, transceiver, transmitter, port, conductors, software and/or hardware for communicating data.

The user device 715 can include one or more computing device(s) 765 that are remote from the service entity computing system 705, the merchant device 710, and the courier device 780. The computing device(s) 765 can include one or more processors 767 and a memory 770. The one or more processors 767 can be any suitable processing device (e.g., a processor core, a microprocessor, an ASIC, a FPGA, a controller, a microcontroller) and can be one processor or a plurality of processors that are operatively connected. The memory 770 can include one or more tangible, non-transitory computer-readable storage media, such as RAM, ROM, EEPROM, EPROM, one or more memory devices, flash memory devices, data registrar, etc., and combinations thereof.

The memory 770 can store information that can be accessed by the one or more processors 767. For example, the memory 770 (e.g., one or more tangible, non-transitory computer-readable storage media, one or more memory devices) can include computer-readable instructions 770A that can be executed by the one or more processors 767. The instructions 770A can be software written in any suitable programming language or can be implemented in hardware. Additionally, or alternatively, the instructions 770A can be executed in logically and/or virtually separate threads on processor(s) 767.

For example, the memory 770 can store instructions 770A that when executed by the one or more processors 767 cause the one or more processors 767 to perform operations such as any of the operations and functions of the computing system(s) (e.g., user devices) described herein (or for which the user device(s) are configured), one or more of the operations and functions for communicating between systems, one or more portions/operations of method 500, and/or one or more of the other operations and functions of the computing systems described herein. The memory 770 can store data 770B that can be obtained. The data 770B can include, for example, any of the data/information described herein.

The computing device(s) 765 can also include a communication interface 775 used to communicate computing device/system that is remote from the user device 715, such as merchant device 710, service entity computing system 705, or courier device 780. The communication interface 775 can include any circuits, components, software, etc. for communicating via one or more networks (e.g., network(s) 717). The communication interface 775 can include, for example, one or more of a communications controller, receiver, transceiver, transmitter, port, conductors, software and/or hardware for communicating data.

The computing device(s) 785 of the courier device 780 can include processor(s) 787 and a memory 790. The one or more processors 787 can be any suitable processing device (e.g., a processor core, a microprocessor, an ASIC, a FPGA, a controller, a microcontroller) and can be one processor or a plurality of processors that are operatively connected. The memory 790 can include one or more non-transitory computer-readable storage media, such as RAM, ROM, EEPROM, EPROM, one or more memory devices, flash memory devices, data registrar, etc., and combinations thereof.

The memory 790 can store information that can be accessed by the one or more processors 787. For example, the memory 790 (e.g., one or more non-transitory computer-readable storage mediums, memory devices) can include computer-readable instructions 790A that can be executed by the one or more processors 787. The instructions 790A can be software written in any suitable programming language or can be implemented in hardware. Additionally, or alternatively, the instructions 790A can be executed in logically and/or virtually separate threads on processor(s) 787.

For example, the memory 790 can store instructions 790A that when executed by the one or more processors 787 cause the one or more processors 787 (the courier device 780) to perform operations such as any of the operations and functions of the display device(s) described herein (or for which such devices are configured), one or more of the operations and functions for communicating between the computing systems/devices, one or more portions/operations of method 500, and/or one or more of the other operations and functions of the computing systems described herein.

The memory 790 can store data 790B that can be obtained (e.g., acquired, received, retrieved, accessed, created, stored). The data 790B can include, for example, any of the data/information described herein. In some implementations, the computing device(s) 785 can obtain data from one or more memories that are remote from the courier device 780.

The computing device(s) 785 can also include a communication interface 795 used to communicate with one or more other system(s) remote from the courier device 780, such as merchant device 710, user device 715, and/or service entity computing system 705. The communication interface 795 can include any circuits, components, software, etc. for communicating via one or more networks (e.g., network(s) 717). The communication interface 795 can include, for example, one or more of a communications controller, receiver, transceiver, transmitter, port, conductors, software and/or hardware for communicating data.

The network(s) 717 can be any type of network or combination of networks that allows for communication between devices. In some implementations, the network(s) 717 can include one or more of a local area network, wide area network, the Internet, secure network, cellular network, mesh network, peer-to-peer communication link and/or some combination thereof and can include any number of wired or wireless links. Communication over the network(s) 717 can be accomplished, for example, via a communication interface using any type of protocol, protection scheme, encoding, format, packaging, etc.

Computing tasks discussed herein as being performed at certain computing device(s)/systems can instead be performed at another computing device/system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks and/or operations can be performed sequentially or in parallel. Data and instructions can be stored in a single memory device or across multiple memory devices.

Aspects of the disclosure have been described in terms of illustrative embodiments thereof. Numerous other embodiments, modifications, and/or variations within the scope and spirit of the appended claims can occur to persons of ordinary skill in the art from a review of this disclosure. Any and all features in the following claims can be combined and/or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein. Also, terms such as “based on” should be understood as “based at least in part on”.

Those of ordinary skill in the art, using the disclosures provided herein, will understand that the elements of any of the claims discussed herein can be adapted, rearranged, expanded, omitted, combined, or modified in various ways without deviating from the scope of the present disclosure. Some implementations are described with a reference numeral for example illustrated purposes and is not meant to be limiting.

What is claimed is:

1. A computing system, comprising:
one or more processors; and
one or more non-transitory, computer-readable media storing instructions that are executable by the one or more processors to cause the computing system to perform operations, the operations comprising:
obtaining data indicative of a merchant location;
generating an initial delivery zone around the merchant location;
populating the initial delivery zone with a plurality of sub-zones;
determining an estimated travel time from the merchant location to each respective sub-zone of the plurality of sub-zones;
comparing the estimated travel time for each respective sub-zone to a threshold travel time;
filtering the sub-zones based at least in part on: (i) the comparing of the estimated travel time for each respective sub-zone to the threshold travel time; or (ii) one or more geographic boundaries;
storing data indicative of the filtered sub-zones as a first geozone associated with a first merchant associated with the merchant location;
obtaining data indicative of initiation of a delivery service application launch, wherein the data comprises at least a drop-off location;
determining the first merchant is an available merchant based at least in part on the first geozone and the drop-off location;
ranking the first merchant and one or more additional merchants from a group of merchants based at least in part on the first geozone associated with the first merchant;
transmitting, to a user device, instructions to cause a user interface to present the ranked merchants in a selectable format;
obtaining user input data indicative of user selection of one or more items associated with at least one merchant of the ranked merchants;
transmitting, to a courier device, data indicative of a request to complete a delivery service associated with the user input data;
obtaining data indicative of acceptance of the request;
obtaining data indicative of one or more progress points associated with the delivery service; and
transmitting, to the user device, instructions to cause the user interface to present updates associated with the one or more progress points associated with the delivery service.

2. The computing system of claim 1, wherein the initial delivery zone comprises a radial delivery zone.

3. The computing system of claim 2, wherein the radial delivery zone comprises a circle with a specified radius and wherein a center of the circle represents the merchant location.

4. The computing system of claim 1, wherein populating the initial delivery zone with a plurality of sub-zones comprises generating a plurality of polygons that fill an area of the initial delivery zone.

5. The computing system of claim 4, wherein the plurality of polygons comprises a plurality of hexagons.

6. The computing system of claim 1, wherein determining the estimated travel time from the merchant location to each respective sub-zone of the plurality of sub-zones comprises determining travel time for a plurality of modalities comprising at least one of: pedestrian, bicycle, electric scooter, or car.

7. The computing system of claim 1, wherein the threshold travel time is determined based on at least one of courier supply, customer demand, or restaurant specific characteristics.

8. The computing system of claim 7, wherein the restaurant specific characteristics comprise at least one of cuisine type, frequency of orders, or frequency of searches.

9. The computing system of claim 1, wherein filtering the sub-zones based at least in part on the comparing of the estimated travel time for each respective sub-zone to the threshold travel time comprises:
comparing a first travel time associated with a first sub-zone to the threshold travel time;
determining the first travel time exceeds the threshold travel time; and
removing the first sub-zone based on the determination that the first travel time exceeds the threshold travel time.

10. The computing system of claim 1, wherein the one or more geographic boundaries comprise at least one of: (i) a body of water, (ii) a mountain range, (iii) a bridge, or (iv) a tunnel.

11. The computing system of claim 1, wherein filtering the sub-zones based at least in part on the comparing of the estimated travel time for each respective sub-zone to the threshold travel time comprises:
comparing a first travel time associated with a first sub-zone to the threshold travel time;
determining the first travel time is less than or equal to the threshold travel time; and
maintaining the first sub-zone based on the determination that the first travel time is less than or equal to the threshold travel time.

12. The computing system of claim 1, the operations comprising:
filtering the sub-zones based at least in part on determining a deliverability status for each respective sub-zone of the plurality of sub-zones by:
determining a first sub-zone of the plurality of sub-zones is in a location that cannot be traversed by available transportation means; and
removing the first sub-zone based on determining the first sub-zone cannot be traversed by available transportation means.

13. The computing system of claim 1, the operations comprising:
determining a geozone for each respective merchant of a plurality of merchants, wherein determining the first geozone comprises, for each respective merchant:
determining a plurality of filtered sub-zones representing sub-zones with travel times between a respective merchant location and the respective sub-zone equal to or less than the threshold travel time;
associating the plurality of filtered sub-zones with the respective merchant; and
storing the respective geozone comprising the plurality of filtered sub-zones associated with the respective merchant.

14. A method comprising:
obtaining data indicative of a merchant location;
generating an initial delivery zone around the merchant location;
populating the initial delivery zone with a plurality of sub-zones;
determining an estimated travel time from the merchant location to each respective sub-zone of the plurality of sub-zones;
comparing the estimated travel time for each respective sub-zone to a threshold travel time;
filtering the sub-zones based at least in part on: (i) the comparing of the estimated travel time for each respective sub-zone to the threshold travel time, or (ii) one or more geographic boundaries;
determining a first geozone for a first merchant;
storing data indicative of the first geozone;
obtaining data indicative of initiation of a delivery service application launch, wherein the data comprises at least a drop-off location;
determining the first merchant is an available merchant based at least in part on the first geozone and the drop-off location;
ranking the first merchant and one or more additional merchants from a group of merchants based at least in part on the first geozone associated with the first merchant;
transmitting, to a user device, instructions to cause a user interface to present the ranked merchants in a selectable format;
obtaining user input data indicative of user selection of one or more items associated with at least one merchant of the ranked merchants;
transmitting, to a courier device, data indicative of a request to complete a delivery service associated with the user input data;
obtaining data indicative of acceptance of the request;
obtaining data indicative of one or more progress points associated with the delivery service; and
transmitting, to the user device, instructions to cause the user interface to present updates associated with the one or more progress points associated with the delivery service.

15. The method of claim 14, wherein determining the first geozone comprises:
determining a plurality of filtered sub-zones representing sub-zones with travel times between a first merchant location and the respective sub-zone equal to or less than the threshold travel time;
associating the plurality of filtered sub-zones with the first merchant; and
storing the first geozone comprising the plurality of filtered sub-zones associated with the first merchant.

16. The method of claim 15, wherein ranking the first merchant and one or more additional merchants from a group of merchants comprising:
obtaining data indicative of a geozone associated with the first merchant;
determining that the geozone associated with the first merchant does not include a sub-zone associated with the drop-off location; and
ranking, in response to determining that the geozone associated with the first merchant does not include a sub-zone associated with the drop-off location, the first merchant as at least one of (i) no rank or (ii) bottom rank.

17. The computing system of claim 14, wherein the initial delivery zone comprises a radial delivery zone.

18. The method of claim 14, wherein populating the initial delivery zone with a plurality of sub-zones comprises generating a plurality of polygons that fill an area of the initial delivery zone.

19. The method of claim 18, wherein the plurality of polygons comprises a plurality of hexagons.

20. One or more non-transitory computer readable media storing instructions that are executable by one or more processors to perform operations comprising:
obtaining data indicative of a merchant location;
generating an initial delivery zone around the merchant location;
populating the initial delivery zone with a plurality of sub-zones;
determining an estimated travel time from the merchant location to each respective sub-zone of the plurality of sub-zones;
comparing the estimated travel time for each respective sub-zone to a threshold travel time;
filtering the sub-zones based at least in part on: (i) the comparing of the estimated travel time for each respective sub-zone to the threshold travel time, or (ii) one or more geographic boundaries;
storing data indicative of the filtered sub-zones as a first geozone associated with a first merchant associated with the merchant location;
obtaining data indicative of initiation of a delivery service application launch, wherein the data comprises at least a drop-off location;
determining the first merchant is an available merchant based at least in part on the first geozone and the drop-off location;
ranking the first merchant and one or more additional merchants from a group of merchants based at least in part on the first geozone associated with the first merchant;
transmitting, to a user device, instructions to cause a user interface to present the ranked merchants in a selectable format;
obtaining user input data indicative of user selection of one or more items associated with at least one merchant of the ranked merchants;
transmitting, to a courier device, data indicative of a request to complete a delivery service associated with the user input data;
obtaining data indicative of acceptance of the request;
obtaining data indicative of one or more progress points associated with the delivery service; and
transmitting, to the user device, instructions to cause the user interface to present updates associated with the one or more progress points associated with the delivery service.
